(19) United States
(12) Patent Application Publication
(10) Pub. No.: US 2002/0122178 A1
(43) Pub. Date: Sep. 5, 2002

(54) Aligning optical components of an optical measuring system

(75) Inventors: David R. McMurtry, Dursley (GB); Benjamin R. Taylor, Stone (GB); Mark A .V. Chapman, Wotton-under-Edge (GB)

Correspondence Address: OLIFF & BERRIDGE, PLC, P.O. BOX 19928, ALEXANDRIA, VA, 22320, US

(73) Assignee: Renishaw plc, Gloucestershire (GB)

(21) Appl. No.: 10/093,615

(22) Filed: Mar. 11, 2002

Related U.S. Application Data
(63) Continuation-in-part of application No. PCT/GB01/03096, filed on Jul. 11, 2001.

(30) Foreign Application Priority Data
Jul. 12, 2000 (GB) 0016976.3

(51) Int. Cl. G01B 11/00

(52) U.S. Cl. 356/401

(57) ABSTRACT

The component parts of an optical measuring system include two housings (20,22) each of which contains optical elements of the system, and a base (10). The two housings are each provided on at least one face with the complementary parts of a kinematic support (18), and the optical components are arranged within the respective housings so that when the kinematic support is engaged the optical components are properly aligned. The base is provided with a kinematic support (16) on its surface which is arranged so that when the base is aligned with a machine axis, any housing placed on the kinematic support will automatically be aligned with the machine axis. Thus by aligning the base with a machine axis, the optical components of the system will automatically be aligned when the housings are connected to the base and to each other using the kinematic supports.

The present invention relates to a method of and apparatus for aligning the components of an optical measuring system preparatory to using them in a measuring operation.

One known type of optical measuring system consists of two or more housings, at least one of which is to be fixed to the bed of the machine and another one of which is to be carried by the movable arm or spindle of the machine. One of the housings contains one or more light sources and detectors, and will be referred to hereinafter as the “source housing” while the other housing contains reflectors, and will be referred to hereinafter as the “reflector housing”. Usually the source housing is maintained in a fixed position on the bed of the machine and the reflector housing is mounted on a movable element of the machine e.g. the machine spindle.

Aligning the optical components is often a time-consuming process which involves firstly the alignment of the source housing so that the beam or beams generated therein are directed along, or parallel to, one or more of the X, Y and Z axes of the machine. Then the reflectors have to be aligned with the beam or beams so that the reflected beams are directed back onto the detectors. Depending on the type of detectors being used the alignment may have to be accurate to within a few arc seconds.

The method and apparatus of the present invention enable the alignment of light sources, reflectors and detectors to be accomplished in all three axes of the machine simply and quickly.

In accordance with one aspect of the present invention there is provided an optical measuring system for a machine having relatively movable machine elements, the optical measuring system having a first part attachable to one of the relatively movable machine elements and which includes at least a light source for directing a light beam along an optical axis and a detector for receiving the light beam after reflection from a reflector, and a second part attachable to another of the relatively movable machine elements and which includes the reflector, wherein at least one of the parts of the optical measuring system is provided with alignment features, the other one of the parts having means for contacting said alignment features to align the second part relative to the first part.

In one embodiment of the invention the alignment features are kinematic seats and the means which contact the kinematic seats are complementary kinematic seats which together form a kinematic mount, and magnets are used to urge the two parts of the kinematic mount together.

The optical components are pre-set within the respective housings so that when the alignment features and the contacting means are in contact, the optical components of the two parts of the system are mutually correctly aligned.

One of the parts of the system may be provided with one part of an adjustable connector which allows its orientation about three orthogonal rotary axes to be altered to a limited extent. The other part of the adjustable connector is connected to one of the relatively movable elements of the machine.

In accordance with an independent aspect of the invention a base is provided which has the seating elements for at least one kinematic seat on at least one of its faces, and may have such a seat on each of the three orthogonal faces thereof. The base is provided with adjustment means to enable it to be aligned with the three orthogonal machine axes. The source housing is then automatically aligned with one of the machine axes when it is attached by its kinematic seat to any one of the kinematic seats of the base.

Alternatively however, three seating elements of a kinematic support may be provided directly on the machine bed in known positions, so that a base plate, or one of the housings can be mounted on the machine bed directly in a known position by providing co-operating seating elements of the kinematic support on the base plate or housing respectively.

In still a further embodiment, in place of a base plate a single ball may form the mounting for the housing. The ball may be mounted rigidly on a base structure so that it remains fixed once the base structure has been positioned on the machine, or may be mounted so as to be adjustable relative to the base structure to provide some compliance in the positioning of the housing on the machine. The base structure is preferably held in place on the machine by a magnetic force. The housing is provided internally with a cup which seats on the ball on the machine so that the housing is pivotable about both horizontal and vertical axes through the centre of the ball so that it can be aligned with the machine axes. Once aligned it is held in place preferably by magnetic forces between the cup and ball. Pivoting of the housing on the ball may be achieved by locating the other housing in the machine spindle and driving the machine spindle towards the housing on the ball to engage the kinematic seating elements between the two housings, and thereafter driving the machine spindle to re-orientate the housing on the machine tool.

In another embodiment of the invention the two housings form two parts of a ball-bar. The ball-bar in this case is modified to provide two separable parts which are connected together using a kinematic support. One of the parts becomes the equivalent of the source housing and contains the light source, the interferometer optics and detector of a linear interferometer, and the other part contains the reflector.

In a modification to this and the previously described embodiments, the light source and/or the detector may be remote to the source housing and connected to it via a fibre optic cable.

To prevent the two parts of the ball bar from sagging (i.e. pivoting about the ball ends) when separated, counterbalance weights may be provided on the opposite sides of the balls, or the cups in which the balls are supported may include magnets to hold the balls in place. The magnetic force in such cases may be supplemented by electromagnets when the parts of the ball-bar are to be separated.

In an alternative embodiment of the invention, the reflector is a plane mirrored surface of one of the parts and has no housing, and the means which contact the alignment features on the source housing are areas of the reflective surface of the plane mirror.

The invention will now be more particularly described, by way of example only, and with reference to the accompanying drawings in which:

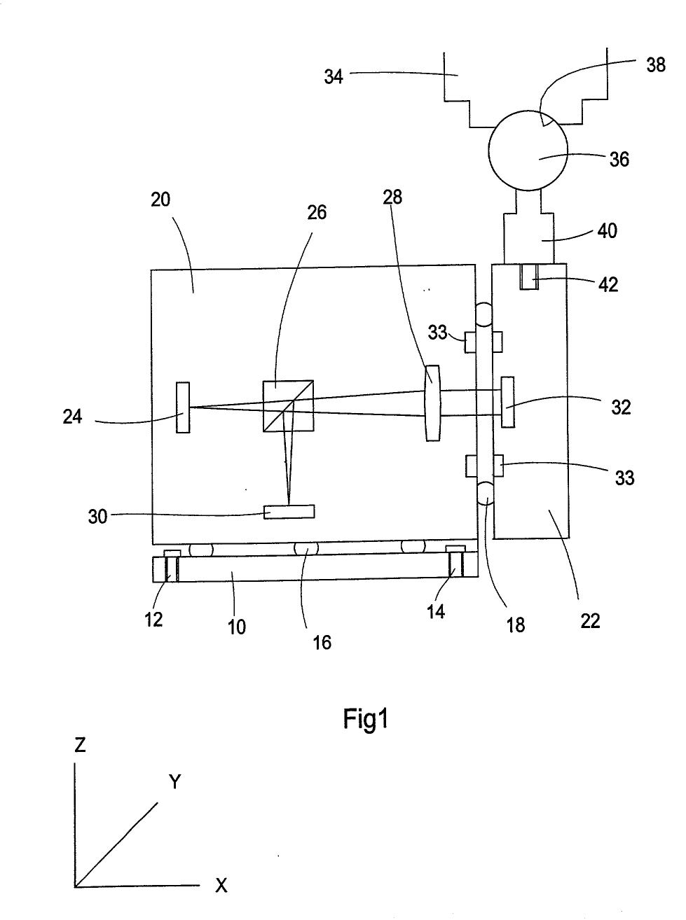

FIG. 1 is a diagrammatic elevation of the component of an optical measuring system according to a first embodiment of the present invention;

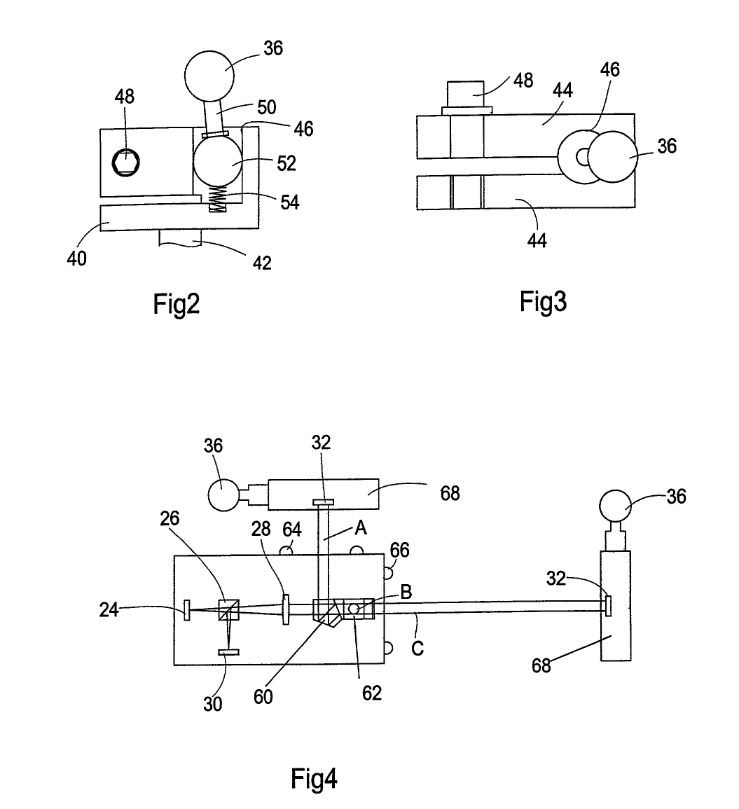

FIGS. 2 and 3 show one embodiment of an adjustable connector;

FIG. 4 illustrates another embodiment of the invention;

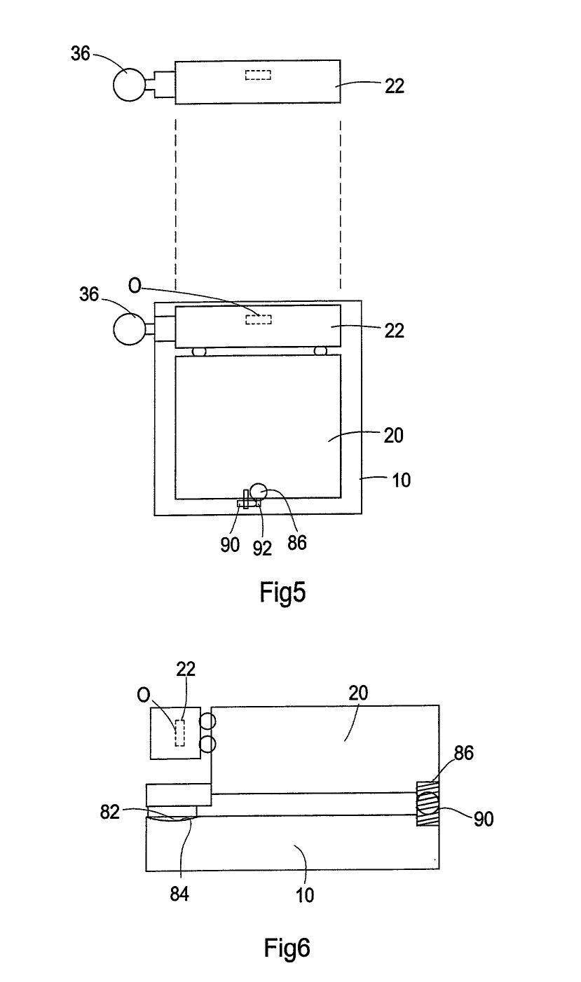

FIGS. 5 and 6 illustrate a further embodiment of the invention;

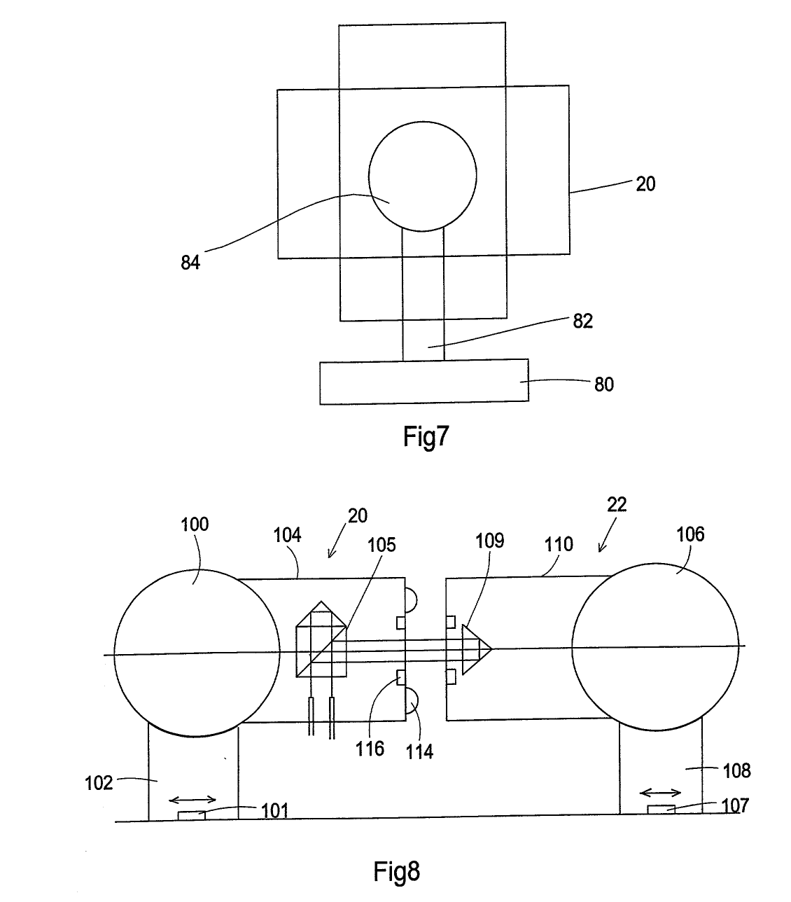

FIG. 7 shows a fixed support for the source housing of the present invention;

FIG. 8 illustrates a further embodiment of the invention; and

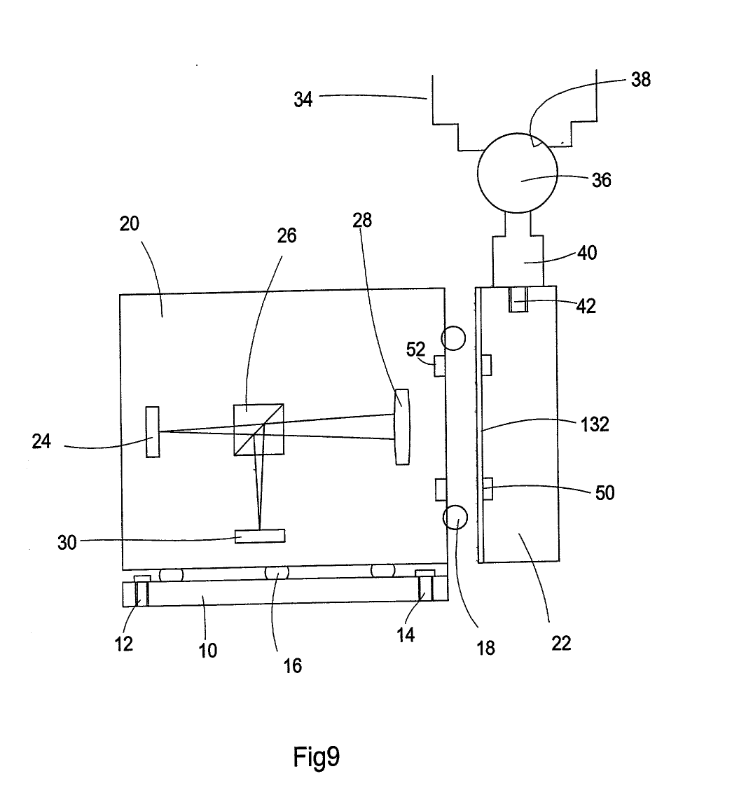

FIG. 9 illustrates a still further embodiment of the invention.

Referring now to the drawings, in FIG. 1 there is shown a first embodiment of an optical measuring system for mounting on a machine.

The optical measuring system includes a base plate 10, a source housing 20 and a reflector housing 22, all of which need to be properly aligned with one or more of the machine axes. The base plate 10 is connected to the bed of the machine by screws 12,14.

In a first embodiment the source housing 20 contains an autocollimator formed in optical sequence by, a light source 24, a beam splitter 26, a collimating lens 28 through which a collimated light beam passes out of the housing, and a detector 30 which receives a return light beam from a reflector 32 in the reflector housing 22 via the beam splitter 26.

The source housing also includes a kinematic seat in the form of three spherical seating elements 16 arranged in a triangular array and spaced at 120° apart. The seating elements 16 co-operate with three vee grooves (not shown) on the base plate to form a conventional kinematic seat for repeatable positioning of the housing on the base plate.

The base plate on its own, or alternatively the base plate and source housing combination, is aligned to one axis, say the X axis, of the machine. If the base plate alone is aligned to the axis, this may be achieved using reference surfaces or edges (not shown) which are located for example by using a touch probe. The source housing is then positioned on the base plate using the kinematic support which is oriented to align the beam from the source parallel to the reference surfaces on the base plate.

However, if the base plate and source housing together are to be aligned together with a machine axis, this can easily be achieved by directing the collimated light beam from the source housing at a suitable optical target, while the source housing is seated on the base plate.

In either case, fine adjustment of the alignment of the base plate in the X, Y plane is enabled by providing a clearance between the screws 12,14 and the respective holes in the base plate through which they pass. Alignment in the XZ and YZ planes is in this example achieved due to the flatness of the machine bed and the accuracy of the manufacture of the base plate and the kinematic support.

The source housing has a further kinematic seat 18 on its front face (i.e. the face which is orthogonal to the beam direction) on which the reflector housing may be seated. The light source and the reflector 32 are aligned in their respective housings during the manufacturing stage to ensure that when the reflector housing is seated in the kinematic seat 18 on the front face of the source housing, the light beam and reflector 32 are properly aligned.

It can be seen therefore that once the source housing 20 is correctly aligned to direct a light beam along one of the machine axes, say the X-axis, the reflector housing can be seated on the kinematic seat on the front face of the source housing, and will automatically be aligned with the beam from the light source 24. Magnets 33 are used to urge the two housings together at the kinematic seat.

In order to take care of any mis-match in position between the machine spindle and the reflector housing when the two are to be connected together, the reflector housing 22 is provided with a limited amount of compliance by using an adjustable connector by means of which the housing 22 can be connected to the spindle 34 of the machine. The adjustable connector has a ball 36 which is to be seated in a spherical socket 38 on the machine spindle. The ball 36 is adjustably supported in a retaining device 40 which, in turn, is connected to the housing 22, by any suitable means, for example a screw-threaded connection 42.

As can be seen in FIGS. 2 and 3 the retaining device consists of a pair of jaws 44 which enclose a cylindrical bore 46. The jaws may be opened and closed by screw-threaded engagement of a clamping bolt 48 with each of the jaws 44. The ball 36 is connected by a stem 50 to a further ball 52 which lies inside the bore 46. A spring 54 is provided which urges the ball 52 out of the bore 46.

Thus the ball 36 can be adjusted through a limited angle to enable it to be engaged in the socket 38 of the machine spindle. The ball 36 is retained in socket 38 in known manner by providing magnets (not shown) in the ball 36, the socket 38, or both. An adjusting device of the type described above is described in more detail in our European Patent No. 508606 B1 and such description is hereby incorporated into this specification by reference.

Thus, once the source housing has been aligned with an axis of the machine, the reflector housing 22 attached to the machine spindle can be brought up to the source housing. With the clamping bolt 48 loosened, the adjustable connector will be free enough to rotate so that the reflector housing will seat in the kinematic seat 18. By this means automatic alignment of the source housing and reflector housing can be ensured. Once seated in the kinematic seat 18 the clamping bolt 48 is tightened to maintain the orientation of the housing 22.

In order to align the source housing 20 with other machine axes several alternative arrangements are possible. In the above-described example, where the source housing is mounted on a base plate, the source housing may have other kinematic seats on its lower surface or on other ones of its orthogonal faces. By this means it can be rotated through 90° in different planes and re-seated on the kinematic seat on the base plate in different orientations. By this means the light beam from the source is directed along different ones of the machine axes. In this case the reflector housing will continue to seat in the same kinematic seat 18 on the source housing so that it will also be aligned with the different axes.

Alternatively a block in the form of a cube or a cuboid may be used instead of a base plate. Such a block would be provided with kinematic seats on various ones of its orthogonal faces so that, by using a single kinematic seat on the source housing, it can be oriented in different directions by engaging its kinematic seat with any one of those on the block. Also in this case the reflector housing will continue to use the same kinematic seat on the source housing.

In a further alternative embodiment the source housing may contain a plurality of sources providing light beams oriented along different machine axes, and may be provided with kinematic seats on those of its faces which are orthogonal to each beam direction. In this case the reflector housing can seat on any respective face and be picked up by the machine spindle to travel in the direction of the respective beam. Instead of a plurality of sources, this embodiment may be modified by providing a single light source and a plurality of beam splitters to direct components of the light beam in different orthogonal directions.

In all of the above embodiments the angles between the orientations of the different kinematic seats or light beam directions will need to be calibrated for squareness measurements to be made.

FIG. 4 illustrates one embodiment which provides three beams from the source housing. As described earlier the source housing includes a single light source 24 which produces a light beam which in turn is passed through a beam splitter/detector arrangement 26/30 to a collimating lens 28. The collimated light beam emerging from the lens 28 is passed to a pair of beam splitting pentaprisms 60 and 62, the outputs from which are three orthogonal collimated beams A, B and C which emerge from the three orthogonal faces of the source housing.

Kinematic seats 64,66 (only two are shown), are provided on the three orthogonal faces of the source housing. By this means the reflector housing 68 carried by the machine spindle may be releasably attached to each of the three faces of the source housing to align it in any one of the three orthogonal directions.

FIGS. 5 and 6 show a further alternative embodiment in which the base plate is rigidly attached to the machine bed, and the source housing 20 is mounted on the base plate by means of an adjustable mounting.

The adjustable mounting includes a part-spherical bearing between the base plate 10 and the source housing 20. The spherical bearing includes a convex portion 82 on the source housing and a concave portion 84 on the base plate. At the rear of the source housing (i.e. the opposite end to the spherical bearing) an adjusting screw 86 bears vertically on the base plate against the action of a spring (not shown) to raise or lower the rear end of the source housing so that it can pivot about the part-spherical surfaces 82,84 in the vertical plane.

Also at the same end of the source housing a horizontal adjusting screw 90 mounted on the base plate pushes against a projection 92 on the source housing against the action of a second spring (not shown) to enable the source housing to pivot about the spherical bearing surfaces 82,84 in the horizontal plane.

The centre of the part-spherical bearing is positioned at a point O which, when the reflector housing is positioned in the kinematic seat 18, lies at the optical centre of the reflector housing so that minor adjustments of the source housing about the pitch and yaw axes during the optical alignment process will not result in any translations of the source housing relative to the reflector housing. Thus when the reflector housing is repositioned in the kinematic seat 18 it will automatically be realigned with the beam from the source housing.

The method of making measurements using the measuring system is the same for all of the embodiments described.

First the source housing is aligned with one of the machine axes as described earlier. The reflector housing is then attached by means of one of the kinematic seats to the face of the source housing from which the light beam is emitted, and the machine spindle is brought into position so that the reflector housing can be picked up using the adjustable connector.

A small initial movement (d) of the spindle is made along the axis to be measured to break the reflector housing from its kinematic seat. Readings from the detectors of the optical measuring system are taken at this position. The spindle is then moved a further incremental distance (d₁) and further detector readings are taken. Angular deviation of the movement is determined from the autocollimator readings and recorded. The process is repeated along the axis taking measurements at incremental positions (d₂) to (dₙ) to build up a record of the angular deviations.

Other optical components may be included in the source and reflector housings. For example a linear interferometer may be included having its laser and detector disposed in the source housing and the interferometer optics disposed in the reflector housing.

Several different arrangements are possible to achieve the object of aligning the two housings with the various machine axes.

For example the base plate may be omitted and the housing which is to be mounted on the fixed part of the machine may be mounted directly onto three balls which are arranged to form a kinematic support directly on the machine bed. These balls may each be mounted adjustably, for example, by means of an adjustable connector as shown in FIGS. 2 and 3 so that their initial positioning is not critical. The retaining devices 40 are first placed in approximately the correct positions to form a kinematic support oriented to align the housing along the required machine axis, (preferably using magnets to clamp them in position in place of the screw-threaded stem 42). A cup connected to the machine spindle is then placed on each ball 36 in turn, and with the adjusting mechanism slackened, the position of each ball 36 is accurately adjusted and recorded from the readings of the machine scales before being fixed.

In another embodiment, instead of a kinematic seating arrangement between the housing 20 and the machine, a single ball may be used which seats in a cup in the housing. This is illustrated diagrammatically in FIG. 7. The ball may be mounted rigidly on a base structure as in the embodiment shown, or may be mounted adjustably in a base structure in a manner similar to the adjustably mounted ball shown in FIGS. 2 and 3. Before attaching the housing, the position of the ball must first be accurately determined, for example, by probing.

Referring now to FIG. 7, the housing 20 is shown on a base structure, or block 80, positioned for example on the machine bed. The block has fixed thereto a pillar 82, which in this example is shown to be vertical, and which has a support in the form of a ball 84 fixed to its free end. The housing 20 has a cup formed as part of its internal structure on which the ball 84 can be supported and magnetically held in position, the housing 20 having an appropriate opening through which the pillar and ball can pass. Thus the housing is capable of pivoting on the support through 360° in the horizontal plane, and through 180° in the vertical plane, an appropriate slot being provided in the housing to avoid the wall of the housing fouling the pillar 82.

To align the housing 20 with a machine axis, the reflector housing 22 is mounted in the machine spindle and driven towards the housing 20, until the kinematic support 18 between the two housings can be engaged. This is initially done by adjusting the position of housing 20 manually. With the housing 20 mounted on a single fixed ball, the housing 22 will need to be mounted in the spindle of the machine with some compliance, e.g. by using the adjustable device shown in FIG. 2.

In an alternative embodiment, the ball is mounted on the machine using the adjustable device, and its position is determined by bringing a cup on the machine spindle into seating relationship with the ball before tightening the adjustment mechanism. The position of the ball can then be determined from the readings on the machine scales. Again, once the position of the ball is determined the housing can be mounted on the ball, and oriented in the direction of the different machine axes using the kinematic seats 18 as described above.

In yet another embodiment as shown in FIG. 8, the two housings 20 and 22 form two parts of a ball-bar. A first part has a ball 100 capable of seating in a cup 102 magnetically retained in the machine by magnets 101. A housing 104 is connected to the ball and contains the light source and interferometer optics of a linear measurement interferometer 105. The second part has a ball 106 capable of seating in a cup 108 magnetically retained on the machine by magnets 107, and has a housing 110 which contains the retroreflector 109 of the interferometer. Preferably the cups each contain three pads on which the balls 100 and 106 are kinematically seated. The two parts of the ball-bar are joined at a kinematic joint 114 formed by seating elements on each part of the ball-bar which are urged into engagement by magnets 116.

The cups 102,108 are of the adjustable type shown in FIG. 2.

In order to align the ball-bar along a machine axis for taking measurements, the cup 102 is positioned on the machine and one of the balls 100,106 is seated in the cup. The machine spindle is provided with a cup which fits the balls 100,106 and is brought down to seat on ball 100. From the readings of the machine scales the position of ball 100 can be determined. The machine spindle is then moved along one of the machine axes by a distance equal to the length of the ball-bar, and the second ball 106 is seated in the second cup, which has previously been positioned in approximately the right place. When proper seating between the cup 108 and ball 106 has been achieved, the adjustment mechanism of the cup is tightened. The ball-bar is now aligned with the machine axis.

To make measurements along the axis, the machine spindle is moved along its axis, carrying the ball 106 and reflector housing by breaking the kinematic joint. The interferometer measures the distance moved.

To prevent sagging of the ball bar when the kinematic joint 114 is broken, the weight of the ball-bar may be counterbalanced, or the magnets used to hold the ball in the cups are made sufficiently powerful to resist the sagging, for example by reinforcing the magnetic force with electromagnets.

To reduce the weight of the ball-bar, the light source may be a remote light source connected to the ball bar by a fibre optic cable.

Because the ball-bar can pivot in the cup on the machine spindle, measurement may be made along both the X and Y axes of the machine by pivoting the ball bar through 90°.

Although the optical measuring system of the invention has been described as having its light source and reflector mounted in respective housings, it is possible to reduce the weight and expense of the system by eliminating at least the housing in which the reflector 32 is mounted. An example of how this is achieved is illustrated in FIG. 9.

In this example the system is shown having many of the components of the FIG. 1 embodiment for ease of reference, although it will be understood that different arrangements are possible.

Referring now to FIG. 9 the source housing 20 contains the same optical components as are described with reference to FIG. 1. The novel feature of this embodiment is the reflector which is provided in the form of a plane mirror 132, the surface area of which is such that it spans the distance between the balls 18 of the kinematic seat on the front face of the source housing.

The plane mirror 132 is connected to a surface of a block 134 which, in this example is carried by the adjustable retaining device 40 which is mounted on the movable element of the machine, i.e. the machine spindle. Alternatively the plane mirror may be a mirrored surface of the block itself.

Alignment of the mirror 132 with the beam from the light source is achieved by causing relative movement between the relatively movable machine elements, preferably by moving the machine spindle in the direction of the source housing with the retaining device slackened. The mirror is brought into gentle contact with the three balls 18 on the housing 20 so that the mirror adjusts its orientation until its plane surface is in contact with all three balls. When this is achieved the adjusting device is tightened. Because the light beam and the kinematic seat on the face of the source housing are correctly aligned during manufacture of the source housing, the contact of the plane surface of the mirror 132 with the balls 18 ensures that the mirror 132 is correctly aligned with the light beam.

This further embodiment may be particularly advantageously used in a ball-bar version of the invention where the plane mirror is attached to one of the ball-bar parts without the need for a housing, thus minimising the weight of the ball-bar.

1. An optical measuring system for a machine having relatively movable machine elements, the optical measuring system having a first part attachable to one of the relatively movable machine elements and which includes at least a light source for directing a light beam along an optical axis and a detector for receiving the light beam after reflection from a reflector, and a second part attachable to another of the relatively movable machine elements and which includes the reflector, wherein at least one of the parts of the optical measuring system is provided with alignment features, the other one of the parts having means for contacting said alignment features to align the second part relative to the first part.

2. An optical measuring system according to claim 1 wherein said alignment features are provided on the first part and the means for contacting the alignment features are provided on the second part.

3. An optical measuring system according to claim 2 wherein, the means on the second part for contacting the alignment features on the first part is a surface on the second part.

4. An optical measuring system according to claim 3 wherein said surface of the second part is a surface of the reflector.

5. An optical measuring system according to claim 3 wherein said surface of the second part is a surface of a housing in which the reflector is mounted.

6. An optical measuring system according to claim 1 wherein the alignment features on the first part comprise elements of a kinematic seat, and the means on the second part for contacting the alignment features on the first part comprise complementary elements of the kinematic seat.

7. An optical measuring system according to claim 1 wherein the alignment features on the first part comprise three balls arranged to form three seating elements of a kinematic support, and the means on the second part for contacting the alignment feature on the firsts part comprises the reflecting surface of a plane mirror.

8. An optical measuring system for a machine comprising two housings each containing at least one component of the optical measuring system, said housings being respectively attached to two relatively movable parts of the machine, each of the housings being provided on at least one face thereof with a complementary part of a mounting device, the mounting device being such that when the two housings are connected together with the two parts of the mounting device in contact with each other, the two housings and the optical components therein are mutually aligned.

9. An optical measuring system according to claim 8 wherein the mounting device is a kinematic mount comprising complementary kinematic seats on the respective housings.

10. An optical measuring system according to claim 8 wherein, at least one of the housings is provided with means for mounting it on one of the machine parts in alignment with a known direction of relative movement of the machine parts so that when the two parts of the mounting device are connected together, the optical components in the two housings are correctly aligned with said direction of relative movement of the machine parts.

11. An optical measuring system according to claim 8 wherein at least one of the housings is provided with an adjustable connector which allows its orientation about at least one of three orthogonal rotary axes to be altered to a limited extent.

12. An optical measuring system according to claim 11 wherein the adjustable connector allows the orientation of the housing to which it is connected to be altered in three orthogonal axes.

13. An optical measuring system according to claim 8 wherein one of the housings is mounted on the machine by means of seating elements in a fixed position on a base which is itself adjustably mounted on the bed of the machine.

14. An optical measuring system according to claim 13 wherein the seating elements form parts of a kinematic support on the base.

15. An optical measuring system according to claim 8 wherein one of the housings is mounted directly on the machine bed by means of three seating elements which form a kinematic support.

16. An optical measuring system according to claim 15 wherein the three seating elements are adjustable.

17. An optical measuring system according to claim 8 wherein one of the housings is mounted on the machine by means of a single ball positioned on the machine which engages with a cup in the housing.

18. An optical measuring system according to claim 17 wherein the ball and cup are urged into engagement by magnetic force.

19. An optical measuring system according to claim 17 wherein the ball is mounted on a fixed base structure on the machine.

20. An optical measuring system according to claim 17 wherein the ball is mounted on an adjustable support on the machine.

21. An optical measuring system according to claim 1 wherein the two housings form two parts of a ball-bar.

22. A method of aligning optical components of an optical measuring system on a machine, said system comprising two parts each providing at least one optical component of the measuring system, the method comprising the steps of:
providing alignment features on at least one of the parts, said alignment features being arranged so that when they are contacted by the other one of the parts the parts are mutually aligned,
mounting the two parts on relatively movable elements of the machine, at least one of the parts being mounted by means of an adjustable connector,
aligning one of the parts with a known direction of relative movement of the machine elements and,
moving the machine elements to bring the two parts together so that the alignment features on said at least one part are contacted by the other part while allowing adjustment of the adjustable connector.

23. A method of aligning optical components of an optical measuring system according to claim 22 comprising the further step of providing complementary alignment features on both of the parts which are adapted to be mutually engaged to provide alignment of the two parts.

24. A method according to claim 23 wherein the complementary alignment features are complementary parts of a kinematic seat.

25. A method according to claim 22 wherein said two parts each comprise housings containing the optical components of the system, and said alignment features are provided on respective surfaces of the housings.

26. A method according to claim 22 wherein one of said two parts is a housing containing at least one optical component of the system, and the other one of said parts is one of the optical components.

27. A method according to claim 26 wherein the housing contains a light source and detector of the optical system and the optical component is a plane mirror.
